(19) United States
(12) Patent Application Publication
(10) Pub. No.: US 2026/0307620 A1
(43) Pub. Date: Oct. 8, 2026

(54) WIRELESS CHARGER WITH NFC READER TO CONTROL VEHICLE ACCESS

(71) Applicant: Deere & Company, Moline, IL (US)

(72) Inventors: BRIAN M. HUENINK, Cedar Grove, WI (US); Sandip Ranjan, PUNE (IN); Tyler J. Van Steenhuyse, Urbandale, IA (US)

(21) Appl. No.: 19/383,870

(22) Filed: Nov. 10, 2025

(30) Foreign Application Priority Data
Apr. 3, 2025 (IN) 202521032868

(51) Int. Cl. B60R 25/24; B60R 16/023; B60R 16/037; B60R 25/01; B60R 25/102; B60R 25/40; G07C 5/02; H02J 7/70

(52) U.S. Cl. CPC B60R 25/24; B60R 16/0231; B60R 16/037; B60R 25/01; B60R 25/102; B60R 25/403; G07C 5/02; H02J 7/731; B60R 2325/103; B60R 2325/205

(57) ABSTRACT

A work vehicle includes a wireless charger configured to charge a mobile phone, the wireless charger including a near field communication (NFC) reader configured to communicate with the mobile phone and receive an identification token from the mobile phone. The vehicle further includes a controller, a display, and a communication network communicating the wireless charger and the display with the controller. The controller may be configured to: receive the identification token from the wireless charger; authenticate the identification token as being associated with an authorized user of the work vehicle; and enable start-up and operation of the work vehicle after the authenticating. The controller may also be configured to personalize operational settings for the authorized user based on stored preferences and to update those settings. The controller may also be configured to track the operation of the work vehicle associated with the authorized user.

### FIELD OF THE DISCLOSURE

The present disclosure relates generally to a system for controlling operator access to a work vehicle.

### BACKGROUND OF THE DISCLOSURE

Vehicle owners face difficulties managing different operator authentications and tracking their work. Owners would like to grant access to operators for a limited period of time to complete tasks while also seeking real-time work tracking.

### SUMMARY OF THE DISCLOSURE

According to an aspect of the present disclosure, a work vehicle includes a wireless charger configured to charge a mobile phone, the wireless charger including a near field communication (NFC) reader configured to communicate with the mobile phone and receive an identification token from the mobile phone. The vehicle further includes a vehicle controller, a display, and a communication network communicating the wireless charger and the display with the vehicle controller. The vehicle controller may be configured to: receive the identification token from the wireless charger; authenticate the identification token as being associated with an authorized user of the work vehicle; and enable start-up and operation of the work vehicle after the authenticating.

According to another aspect of the disclosure a method of operating a work vehicle may include: receiving a mobile phone on a wireless charger including a near field communication (NFC) reader; communicating the identification token from the wireless charger to a vehicle controller; authenticating the identification token with the controller as being associated with an authorized user of the work vehicle; and enabling start-up and operation of the work vehicle after the authenticating.

Other features and aspects will become apparent by consideration of the detailed description and accompanying drawings.

### BRIEF DESCRIPTION OF THE DRAWINGS

FIG. 1 is a schematic side elevation view of a work vehicle in the form of an excavator embodying the access control system of the present disclosure.

FIG. 2 is a schematic perspective view of the operator’s station inside of the operator’s cab of the work vehicle of FIG. 2.

FIG. 3 is an enlarged schematic perspective view of the command arm of the operator’s station of FIG. 2.

FIG. 4A is a perspective view of the wireless charger of the command arm of FIG. 3.

FIG. 4B is an elevation view of the wireless charger with the clamping device in an extended position.

FIG. 4C is an elevation view of the wireless charger with the clamping device in a retracted position.

FIG. 5 is a schematic view of the access control system.

FIG. 6 is a schematic view of the controller of the work vehicle.

FIG. 7 is a flow chart depicting one method of operating the work vehicle.

FIG. 8 is a schematic side elevation view of a work vehicle in the form of a tractor embodying the access control system of the present disclosure.

### DETAILED DESCRIPTION

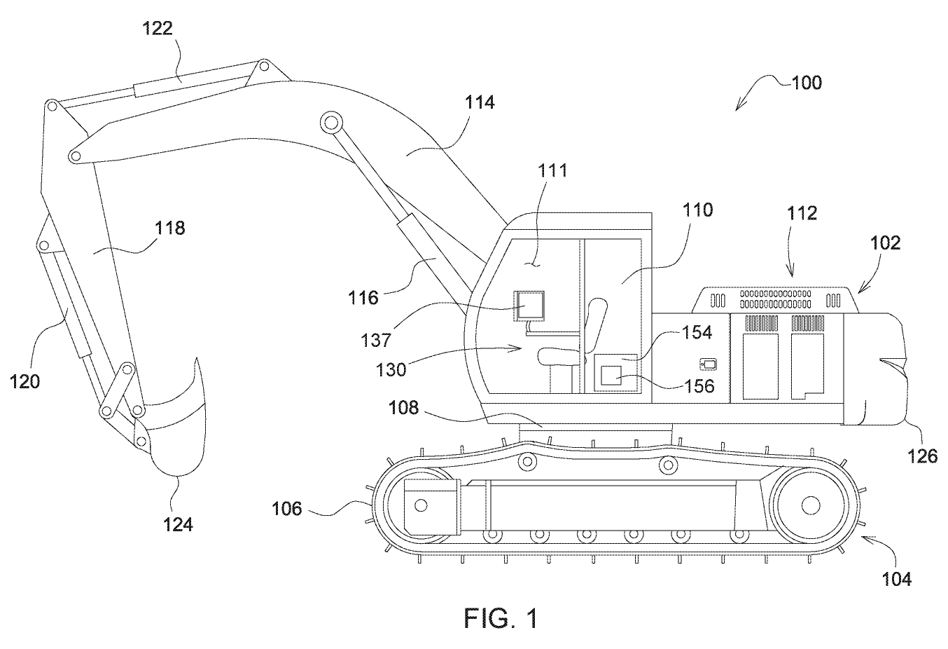

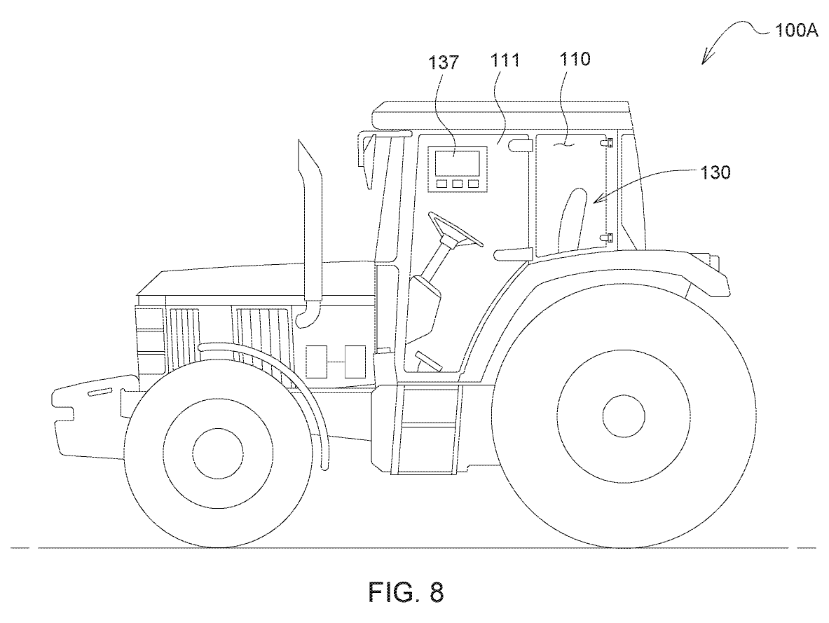

Referring to FIG. 1, a work vehicle 100 is depicted in the form of an excavator. It will be appreciated that the present disclosure is applicable to any type of work vehicle including all types of construction equipment, agricultural equipment and forestry equipment. Similarly in FIG. 8 a work vehicle 100A is depicted in the form of an agricultural tractor.

The work vehicle 100 of FIG. 1 includes a chassis comprising an upper frame 102 pivotally mounted to an undercarriage 104. The upper frame 102 can be pivotally mounted on the undercarriage 104 by means of a swing pivot 108. The upper frame 102 is rotatable about 360 degrees relative to the undercarriage 104 on the swing pivot 108. A hydraulic motor (not shown) can drive a gear train (not shown) for pivoting the upper frame 102 about the swing pivot 108.

The undercarriage 104 can include a pair of ground-engaging mechanisms such as tracks 106 on opposite sides of the undercarriage 104 for moving along the ground. Alternatively, the machine 100 can include more than two tracks or wheels for engaging the ground. The upper frame 102 includes an operator’s cabin or operator’s cab 110 in which the machine operator controls the machine. The operator’s cab 110 may include a lockable door 111 providing access to the operator's cab 110.

The work vehicle 100 also includes a boom 114 that extends from the upper frame 102 adjacent to the cab 110. The boom 114 is rotatable about a vertical arc by actuation of a pair of boom cylinders 116, only one of which is visible in FIG. 1. A dipper stick or arm 118 is rotatably mounted at one end of the boom 114 and its position is controlled by a hydraulic arm cylinder 122. There may be two hydraulic arm actuators 122. At the end opposite the boom 114, the dipper stick or arm 118 is rotatably coupled to a work implement or bucket 124 that is pivotable relative to the arm 118 by means of a hydraulic implement pivoting cylinder 120. There may be two hydraulic implement pivoting cylinders 120.

The upper frame 102 of the work vehicle 100 includes an outer shell cover over an engine assembly 112. At an end opposite the cab 110, the upper frame 102 includes a counterweight body 126.

The operator of the work vehicle 100 may manually control the boom cylinders 116, the hydraulic arm cylinders 122, the hydraulic implement pivoting cylinders 120 and the hydraulic motor that pivots the upper frame 102 about the undercarriage 104 on the swing pivot 108. The operator may control these various machine components from an operator’s control station 130 located within the operator’s cab 110.

The work vehicle 100A of FIG. 8 is an agricultural tractor including an operator’s cab 110 and operator’s control station 130 substantially similar to those described herein for the work vehicle 100 of FIG. 1.

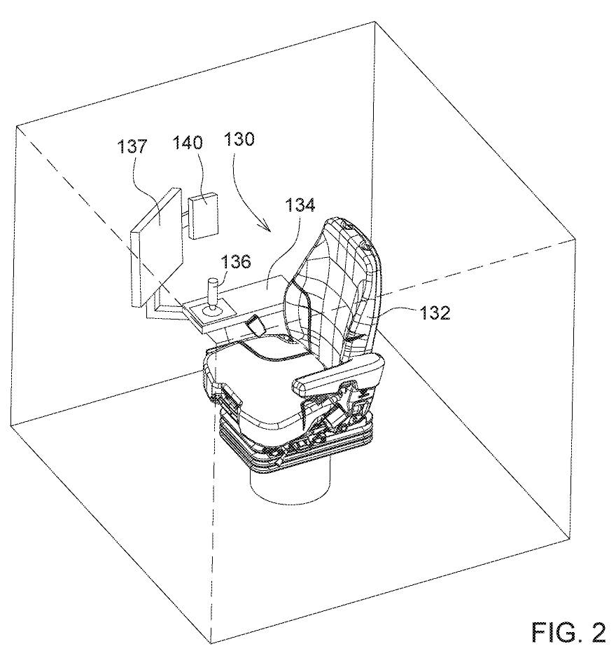

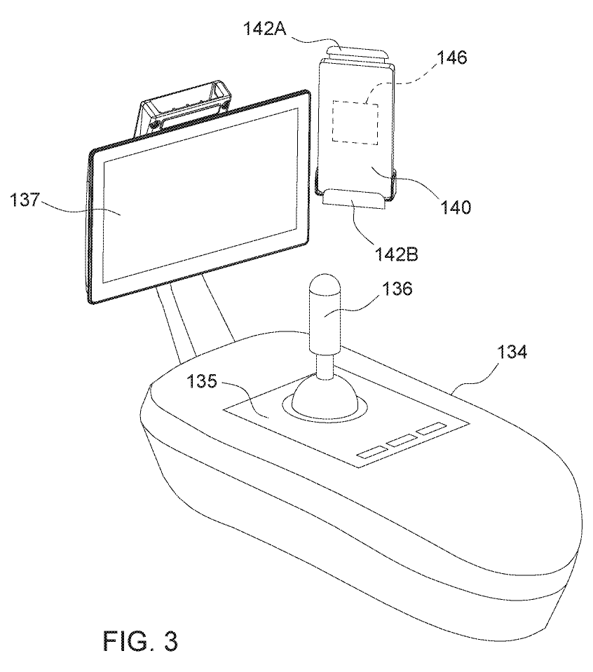

Details of the operator’s control station 130 are further shown in FIGS. 2 and 3. The control station 130 may include an operator’s seat 132 which may be rotatable or otherwise adjustable in position within the operator’s cab 110. The operator’s seat 132 may include a command arm 134 carrying a control panel 135 including various control devices 136 and a display 137. A wireless charger 138 may be attached to the command arm 134 or otherwise located adjacent the operator’s seat 132. In FIG. 3 the wireless charger 138 is shown attached to the display 137 so that a mobile phone 140 engaged with the wireless charger 138 is held in a generally vertical orientation. According to some embodiments, the mobile phone 140 must be within a preset distance of the wireless charger 138, or placed on the wireless charger 138, before the controller 200 will authenticate the token.

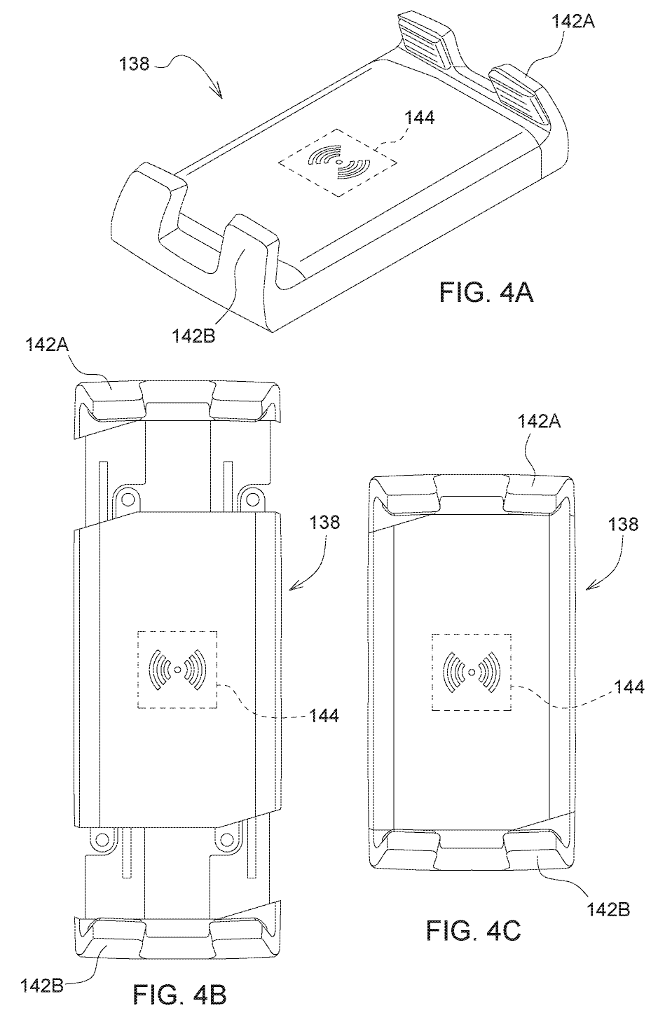

FIGS. 4A-4C show further details of one embodiment of the wireless charger 138 in which the wireless charger 138 includes a clamping arrangement or clamp 142 configured to hold the mobile phone 140 in place on the wireless charger 138. FIG. 4A is a perspective view of the wireless charger 138 which is configured to charge the mobile phone 140 in a wireless manner. The wireless charger 138 may include a near field communication (NFC) reader 144 embedded in the wireless charger 138 and configured to communicate with the mobile phone 140 and to receive an identification token from the mobile phone 140. The identification token is a packet of electronic identification information contained on the mobile phone 140 and communicated by an NFC chip 146 of the mobile phone 140 with the NFC reader 144 of the wireless charger 138.

FIGS. 4B and 4C show the clamping device 142 of the wireless charger 138 in a retracted and an extended position, respectively. To place the mobile phone 140 on the wireless charger 138 the clamping device 142 may first be extended so that the mobile phone can be placed on the wireless charger 138, then the clamping device 142 can be retracted until it snugly engages the mobile phone 140 to hold the phone in place as schematically illustrated in FIG. 3. The clamping device 142 may include an upper clamp component 142A and a lower clamp component 142B which are movable relative to each other to receive and hold the mobile phone 140 therebetween.

Alternatively, a generally horizontally oriented wireless charger 138 could have the mobile phone 140 laid in a receiving zone of the wireless charger 138 without the use of a clamping device.

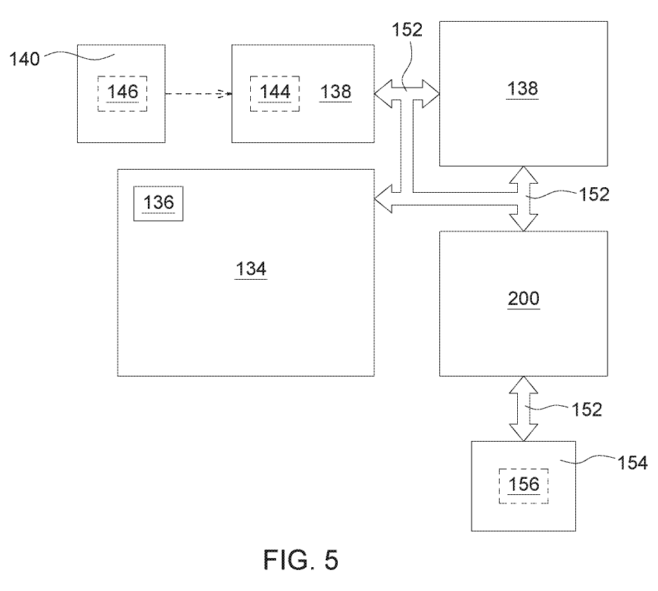

The work vehicle 100 includes an access control system 150 schematically illustrated in FIG. 5. The access control system 150 includes the wireless charger 138 described above, the command arm 134 with its various control devices 136 and the display 137, and a vehicle controller 200. A communications network 152, which may for example be a Controller Area Network (CAN) 152, communicates the various components of the access control system 150, including communicating the wireless charger 138 and the display 137 with the vehicle controller 200. The NFC reader 144 of the wireless charger 138 is configured to receive the identification token from the mobile phone 140 by near field communication, and then to send the identification token to the vehicle controller 200 over the CAN network 152.

The previously mentioned lockable door 111 of the operator’s cab 110 may have an access pad 154 located adjacent to the door, and the access pad 154 may include a second NFC reader 156 configured to provide a tap-to-access communication with the mobile phone 140 to unlock the lockable door 111.

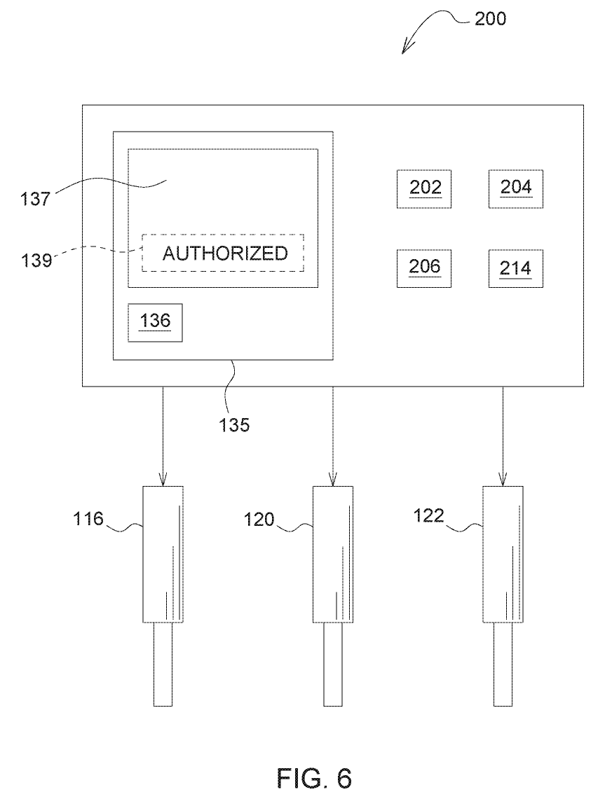

As schematically illustrated in FIG. 6, the work vehicle 100 includes the controller 200. The controller 200 may also be referred to as an automatic controller 200. The controller 200 may operate the access control system 150 in addition to controlling operation of various vehicle components such as the various actuators 116, 120 and 122 discussed above. The controller 200 may be part of the machine control system of the work vehicle 100, or it may be a separate control module. The controller 200 may be mounted in the operators’ cab 110 or located elsewhere on the vehicle 100 or even remotely located.

Controller 200 includes or may be associated with a processor 202, a computer readable medium 204, a data base 206 and an input/output module which may be the control panel 135 having the display 137. An operator input in the form of the input/output device 136, such as a keyboard, joystick or other user interface, is provided so that the human operator may input instructions to the controller. It is understood that the controller 200 described herein may be a single controller having all of the described functionality, or it may include multiple controllers wherein the described functionality is distributed among the multiple controllers.

Various operations, steps or algorithms as described in connection with the controller 200 can be embodied directly in hardware, in a computer program product 214 such as a software module executed by the processor 202, or in a combination of the two. The computer program product 214 can reside in RAM memory, flash memory, ROM memory, EPROM memory, EEPROM memory, registers, hard disk, a removable disk, or any other form of computer-readable medium 204 known in the art. An exemplary computer-readable medium 204 can be coupled to the processor 202 such that the processor can read information from, and write information to, the memory/ storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The controller 200 may be configured, such as through programming 214 stored on the computer-readable medium 204 and implemented by the processor 202, to perform the various functions of the access control system 150.

The controller 200 may be configured to receive the identification token from the wireless charger 138. As noted, the identification token may be received over the CAN network 152.

The controller 200 may be configured to authenticate the identification token as being associated with an authorized user of the work vehicle 100. The controller 200 may have various pre-authorization information stored in the computer readable medium 204, identifying the identification tokens associated with various authorized users. Additionally, the controller 200 may be configured to communicate remotely with an administrator of the work vehicle 100 to obtain real time authorization for a new user of the work vehicle. Upon receiving a request for a new authorization, the administrator may provide an authorized identification token to the mobile phone 140 of the new user via text message or the like.

The controller 200 may be configured to enable start-up and operation of the work vehicle after the authenticating. Enablement of start-up may include activating an electrical system of the work vehicle so that the authorized user may start the engine assembly 112. Enablement of the operation of the work vehicle 100 may include activating operation of the control devices 136 so that the authorized user may operate the various actuators such as 116, 120, and 122 of the work vehicle 100, or so that the authorized user may operative the advance drive tracks 106 to move the work vehicle over the ground surface.

The controller 200 may be configured to track operation of the work vehicle 100 by the authorized user. The controller 200 may observe the location and operational state of the work vehicle 100 through the use of various sensors and record that information to provide the system administrator with a record of the operational activity of the authorized user of the work vehicle 100.

The controller 200 may be configured to personalize one or more operational settings of the work vehicle 100 for the authorized user based on stored preferences of the authorized user. For example, the stored preferences may include position of the operators seat 132, environmental controls such as heating and cooling of the operator’s cab 110, and the like.

The controller 200 may be configured to direct the display 137 to display a visual indication 139 as to whether the identification token received by the controller 200 is associated with an authorized user.

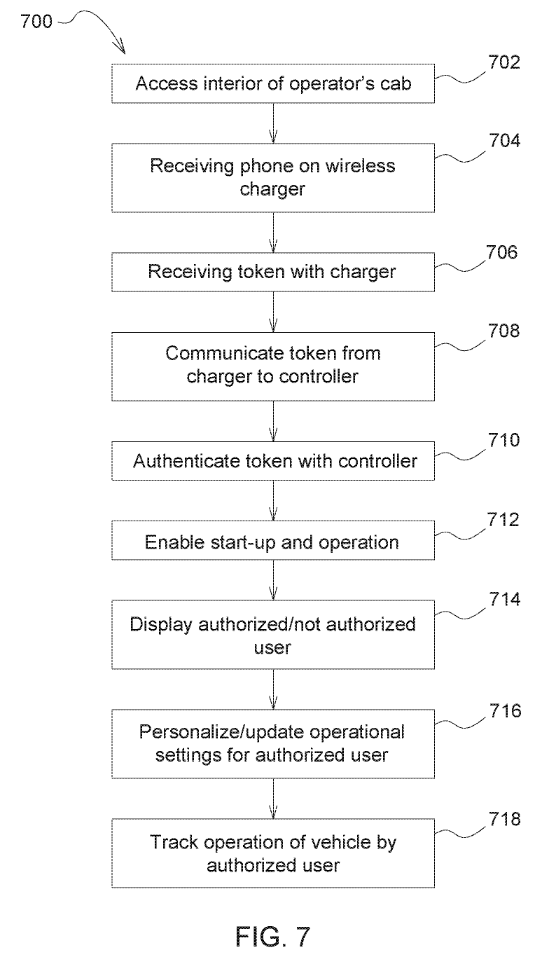

FIG. 7 illustrates in flow chart form one method of operating the work vehicle 100, which method is generally designated as 700. In an optional first step 702 the authorized user accesses the interior of the operator’s cab 110 by unlocking the locked door 111 using the user’s mobile phone 140 to tap the access pad 154 so that the identification token from the NFC chip 146 of the user's mobile phone 140 is communicated to the second NFC reader 156 of the access pad 154. The second NFC reader 156 may communicate that identification token to the controller 200 via the CAN network 152, and upon confirmation that the user is authorized the controller 200 may direct the lockable door 111 to unlock.

At step 704, after accessing the interior of the operator’s cab 110 the authorized user may place his or her mobile phone 140 such that the phone 140 is received on the wireless charger 138 as seen in FIG. 3. Then at step 706 the NFC reader 144 of wireless charger 138 receives the identification token from the NFC chip 146 of phone 140 and at step 708 the NFC reader 144 communicates that identification token to the controller 200 over CAN network 152 to indicate that the user is in place within the operator’s cab 110. Placement of the wireless charger 138 with its NFC reader 144 adjacent the operator’s seat 132 provides confidence that the user is actually seated in the operator's seat 132 when the authorization is confirmed by the controller 200.

Then at step 710 the controller 200 authenticates the identification token as being associated with an authorizer user of the work vehicle 100, and then after authentication at step 712 the controller 200 enables start-up and operation of the work vehicle.

As further indicated at step 714 the controller 200 may display on the display 137 of the work vehicle 100 a visual indication as to whether or not the identification token received by the controller 200 from the wireless charger 138 is associated with an authorized user.

Additionally at step 716 the method may include personalizing one or more operational settings of the work vehicle for the authorized user based on stored preferences of the authorized user. The controller 200 may further update any stored preferences to correspond to any adjustments in machine parameters set by the authorized user during operation of the work vehicle 100.

Additionally at step 718 the controller 200 may track operation of the work vehicle 100 by the authorized user and may generate and store a record of the operation by the authorized user associated with other records for that authorized user.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A work vehicle, comprising:
a wireless charger configured to charge a mobile phone, the wireless charger including a near field communication (NFC) reader configured to communicate with the mobile phone and receive an identification token from the mobile phone;
a controller;
a display; and
a communication network communicating the wireless charger and the display with the controller;
wherein the controller is configured to:
receive the identification token from the wireless charger;
authenticate the identification token as being associated with an authorized user of the work vehicle; and
enable start-up and operation of the work vehicle after the authenticating.

2. The work vehicle of claim 1, wherein:
the communication network is a Controller Area Network (CAN) and the NFC reader of the wireless charger is configured to send the identification token to the controller over the CAN.

3. The work vehicle of claim 1, wherein:
the controller is further configured to track operation of the work vehicle by the authorized user.

4. The work vehicle of claim 1, wherein:
the controller is further configured to personalize one or more operational settings of the work vehicle for the authorized user based on stored preferences of the authorized user.

5. The work vehicle of claim 1, wherein:
the controller is further configured to direct the display to display a visual indication as to whether or not the identification token is associated with an authorized user.

6. The work vehicle of claim 1, wherein:
the wireless charger includes a clamp configured to hold the mobile phone in place on the wireless charger.

7. The work vehicle of claim 1, wherein:
the wireless charger is located adjacent to an operator’s station of the work vehicle.

8. The work vehicle of claim 1, further comprising:
an operator’s cabin including a lockable door; and
a second NFC reader located external of the operator’s cabin and configured to provide a tap-to-access communication with the mobile phone to unlock the lockable door.

9. A method of operating a work vehicle, comprising:
receiving a mobile phone on a wireless charger including a near field communication (NFC) reader;
receiving an identification token from the mobile phone with the wireless charger;
communicating the identification token from the wireless charger to a controller;
authenticating the identification token with the controller as being associated with an authorized user of the work vehicle; and
enabling start-up and operation of the work vehicle after the authenticating.

10. The method of claim 9, further comprising:
tracking operation of the work vehicle by the authorized user with the controller.

11. The method of claim 9, further comprising:
personalizing one or more operational settings of the work vehicle for the authorized user with the controller based on stored preferences of the authorized user.

12. The method of claim 9, further comprising:
displaying on a display of the work vehicle a visual indication as to whether or not the identification token is associated with an authorized user.

13. The method of claim 9, further comprising:
accessing a locked operator’s cabin of the work vehicle by tap-to-access communication of the mobile phone with a second NFC reader located external of the operator’s cabin.
